(19) United States
(12) Patent Application Publication
(10) Pub. No.: US 2025/0182094 A1
(43) Pub. Date: Jun. 5, 2025

(54) UNIFIED IDENTITY REGISTRY

(71) Applicant: Adobe Inc., San Jose, CA (US)

(72) Inventors: David Brian Humpherys, Lehi, UT (US); William Brandon George, Pleasant Grove, UT (US); Jonathan Lancar, Redwood City, CA (US)

(73) Assignee: Adobe Inc., San Jose, CA (US)

(21) Appl. No.: 18/528,171

(22) Filed: Dec. 4, 2023

(51) Int. Cl. G06Q 20/36

(52) U.S. Cl. CPC G06Q 20/3678

(57) ABSTRACT

Techniques for generation of a unified identity registry are described that support integration and analysis of non-blockchain based user data and blockchain-based user data. A processing device, for instance, monitors an interaction between a client device associated with a user and a digital service provided by a digital service provider. Based on the interaction, the processing device determines a non-blockchain based identifier as well as a blockchain based identifier associated with the user and generates an association between the identifiers. The processing device then generates an identity asset that includes the association for inclusion in an identity registry. The processing device performs a variety of analysis as part of maintaining the identity registry, such as generating segments of identity assets and generating rules to govern access and use of the identity assets. The processing device then grants access to the identity registry based on the rules.

### BACKGROUND

Data sharing between service provider systems is confronted with a variety of technical challenges caused by an amount of data being shared, nature of the data, and how the data is collected and managed by respective service provider systems. A service provider system, for example, collects user data using a proprietary application and maintains the user data across siloed information systems. However, conventional intermediary techniques that have been designed to assist in data sharing between service provider systems introduce errors and uncertainty when confronted with these challenges. For example, conventional techniques fail to collect holistic representations of user data as the ways in which users interact with service provider systems evolve. Consequently, conventional data sharing techniques include incomplete and inaccurate information repositories, are computationally inefficient, and result in increased power consumption to implement.

### SUMMARY

Techniques and systems for a unified identity registry are described that integrate non-blockchain based data with blockchain-based data. In an example, an identity registry system monitors an interaction between a client device associated with a user and a digital service provided by a digital service provider. The identity registry system determines a non-blockchain based identifier, such as an email address, associated with the user based on the interaction. The identity registry system further detects that the interaction includes a blockchain event and determines a blockchain based identifier associated with the user, e.g., a blockchain wallet ID. The identity registry system then generates an identity asset that includes an association between the identifiers for inclusion in an identity registry.

The identity registry includes multiple identity assets, and the identity registry system performs a variety of analysis as part of maintaining the identity registry. For instance, the identity registry system generates segments of identity assets based on attribution of blockchain events to non-blockchain events and vice versa. The identity registry system further generates and implements rules to govern access and use of the identity assets, such as to control data sharing of identity assets included in the identity registry. In this way, the techniques described herein provide a holistic and customizable data management and sharing system that integrates non-blockchain based user data and blockchain-based user data into a comprehensive repository.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a unified identity registry environment in an example implementation that is operable to employ the techniques described herein.

FIG. 2 is an illustration of a system in an example implementation showing operation of the registry management module of FIG. 1 in greater detail as generating an identity asset.

FIG. 3 depicts a flow diagram of a procedure in an example implementation of generation of an identity asset as part of a unified identity registry.

FIG. 4 is an illustration of a system in an example implementation of generating and maintaining an identity registry.

FIG. 5 depicts a flow diagram of a procedure in an example implementation of generation of an audience segment as part of managing a unified identity registry.

FIG. 6 is an illustration of a system in an example implementation of generating one or more rules as part of maintaining an identity registry.

FIG. 7 depicts a flow diagram of a procedure in an example implementation of providing access to an identity asset as part of managing a unified identity registry.

FIG. 8 illustrates an example system including various components of an example device that can be implemented as any type of computing device as described and/or utilized with reference to FIGS. 1-7 to implement embodiments of the techniques described herein.

### DETAILED DESCRIPTION

### Overview

Service provider systems engage in data sharing with other service provider systems in an attempt to provide personalized services and support informed decision making. However, data sharing between service providers faces a host of technical problems related to collection and maintenance of the data. For instance, the way in which users interact with service provider systems is in the midst of a paradigm shift from traditional “Web 2.0” modalities to “Web 3.0” modalities. Conventional data sharing techniques are unable to effectively collect, maintain, and share data based on these emerging modalities, and thus suffer from limitations related to incomplete information including reduced computational efficiency.

Consider, for instance, the popularization of “Web 3.0” modalities that focus on interoperability and decentralization such as blockchain based technologies. Generally, a blockchain is a decentralized digital ledger that records transactions of tokens across a network of computers. A blockchain is maintained by a distributed network of nodes and includes a chain of blocks associated with a set of transactions. Data that is recorded on a blockchain is difficult to alter, which provides security and transparency for participants. While blockchain based technologies support a variety of features to deliver products and services to users, blockchain based user data is detached from “traditional” forms of user data. Thus, conventional data sharing systems treat blockchain based user data and non-blockchain based user data as incompatible, and as such encounter limited insights and increased computational overhead.

Accordingly, techniques and systems for a unified identity registry are described that support integration and analysis of non-blockchain based user data and blockchain-based user data. Whereas conventional systems collect limited user data using proprietary applications, the techniques described herein generate an association between non-blockchain based identifiers and blockchain-based identifiers in real time and further analyze such associations. By doing so, these techniques overcome the technical challenges that hinder conventional data collection and sharing systems.

Consider an example in which a user of a client device interacts with a digital service provided by a service provider system. In this example, the service provider system is an airline, and the user of the client device interacts with a web application provided by the airline to explore flight options. The web application further supports blockchain-based events, such as exchange of cryptocurrencies for token-based tickets via a blockchain network.

A processing device implements an identity registry system to monitor the interaction between the client device and the service provider system. As part of the monitoring, the identity registry system obtains client data associated with the user that includes a non-blockchain based identifier. The non-blockchain based identifier, for instance, is one or more of an email address, phone number, username, user profile, etc. In some examples, the client data further includes additional information such as data about the client device, data about the interaction, historical interaction data, projected interaction data, etc. In this example, the identity registry system obtains personally identifiable information (“PII”) for the user that includes an email address of the user.

The identity registry system is further operable to detect that the interaction includes a blockchain-based event, such as authentication of a blockchain identifier associated with the client device. The blockchain identifier, for instance, is a blockchain wallet ID that is associated with the user's blockchain wallet. The wallet ID includes a string of characters that represents a pseudonymous public identifier for the blockchain wallet and supports exchange of blockchain based assets. Continuing with the above example, the user of the client device transacts with the airline to acquire a token-based ticket using the blockchain wallet ID. As part of the digital transaction, the blockchain identifier associated with the client device (e.g., the wallet ID) is authenticated and obtained by the identity registry system in real time.

The identity registry system then generates an association between the non-blockchain based identifier (e.g., the email address of the user) and the blockchain identifier, e.g., the wallet ID. Whereas conventional data sharing techniques are unable to integrate blockchain-based user data with non-blockchain based user data, the techniques described herein support generation of a unified representation of the user across both blockchain and non-blockchain environments.

For instance, the identity registry system generates an identity asset that includes the association between the client data and the blockchain identifier. The identity registry system is further operable to augment the identity asset by acquiring additional blockchain-based information associated with the user and/or the client device. For example, the identity registry system obtains historical blockchain activity data associated with the client device and incorporates the historical activity data into the identity asset. Further, the identity registry system is operable to acquire and augment the identity asset with additional non-blockchain based data such as additional user identifiers, non-blockchain events related to the digital service, specifications of the client device, etc.

Once generated, the identity registry system is configured to output the identity asset, such as for communication over a network to one or more service provider systems. Alternatively or additionally, the identity registry system includes the identity asset into an identity registry. For instance, the identity registry system generates an identity registry that includes a plurality of identity assets generated in accordance with the techniques described herein.

Continuing with the above example, for each user that interacts with the web application provided by the airline, the identity registry system generates an identity asset for inclusion in the identity registry. The identity registry further includes identity assets generated by the identity registry system based on interactions with additional service provider systems, e.g., service provider systems other than the airline. The identity registry system is further operable to iteratively update the identity registry, such as to add/remove identity assets and/or update identity assets in real time or asynchronously.

The identity registry system analyzes the identity assets to generate segments within the identity registry, e.g., audience segments that include a plurality of identity assets. Because the identity assets in the identity registry include both non-blockchain based data and blockchain based data, the audience segments are based on either or both the non-blockchain based data and the blockchain based data. For instance, the identity registry system generates an audience segment based on a correspondence of a non-blockchain event to a blockchain event.

Continuing with the above example, the identity registry system generates an audience segment that includes identity assets that exhibit a correspondence between a non-blockchain event, e.g., exposure to a particular feature of the web application of the airline, and a blockchain event, e.g., authentication of a wallet ID. The identity registry system is further operable to perform a variety of functionality using the audience segments, such as to communicate an instance of digital content to a particular audience segment, engage in a blockchain event with the audience segment, etc.

As part of maintaining the identity registry, the identity registry system defines access rules and/or usage rules associated with the identity assets and/or the audience segments. Generally, a usage rule regulates use of a particular identity asset or audience segment. In other words, a usage rule regulates “how” an identity asset and/or an audience segment is to be used. By way of example, a usage rule restricts use of an identity asset based on a privacy constraint, such as to not use the identity asset in a manner that would compromise PII of the identity asset.

An access rule regulates access rights of the identity asset, such as by various service provider systems. That is, the access rules dictate “who” is allowed to access “what” aspects of identity assets and/or audience segments. In an example, an access rule restricts a particular entity from accessing one or more identity assets. In an additional or alternative example, an access rule provides “governed access” to an identity asset for a particular entity, such that the particular entity is allowed to access the identity asset in a limited manner without visibility into the information included in the identity asset.

In this way, the identity registry system is configurable to manage data sharing between different service provider systems. For instance, the identity registry system receives a request for access to the identity registry, such as to access a particular identity asset. The identity registry system determines usage rules and/or access rules associated with the identity asset. The identity registry system then provides access (or restricts access) based on the usage rules and/or the access rules.

In the context of the above example, the airline partners with several other service provider systems, e.g., a partner airline, a hotel chain, and a car rental company, and wishes to implement a collaborative block-chain powered campaign with the travel partners. The identity registry system receives a request to provide access to an audience segment stored in the identity registry to the travel partners. In some examples, the request is generated by one or more of the service provider systems, e.g., the airline and/or the partners of the airline. Alternatively or additionally, the request is generated automatically and without user intervention.

The identity registry system determines a usage rule and an access rule associated with the audience segment. In this example, the rules specify that the travel partners are allowed to download data directly from the registry that pertains to the audience segment, however, are unable to view PII of the audience segment. The identity registry system then provides access to the audience segment in accordance with the access rule and the usage rule. In this way, the techniques described herein provide a holistic and customizable data sharing and management system that integrates non-blockchain based user data and blockchain-based user data into a comprehensive repository. These techniques reduce incidence of “duplicative efforts” by service provider systems and thereby increase computational efficiencies and optimize resource allocation.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Term Examples

As used herein, the term “blockchain network” refers to devices and technology to support a decentralized and distributed ledger modality that enables secure and transparent record-keeping of transactions across multiple participants in a network. A blockchain network, for instance, includes a chain of blocks that each include a set of transactions and/or additional digital records. The blocks are linked together in a chronological and cryptographic chain to form the blockchain.

As used herein, the term “blockchain node” refers to a component of the blockchain network. A blockchain node, for instance, includes a processing device that participates in operation of the blockchain network by maintaining a copy of a blockchain ledger, validating transactions, and/or communicating with other nodes in the network. In an example, blockchain nodes are interconnected to exchange data via a network, e.g., as a peer-to-peer network in a distributed and decentralized manner. In an example, one or more of a service provider system, client device, and/or an identity registry system represent blockchain nodes.

As used herein, the term “blockchain identifier” refers to a string of characters associated with a participant in the blockchain network. The blockchain identifier, for instance, identifies a user/entity within the blockchain network in a pseudonymous manner. In one or more examples, the blockchain identifier includes a blockchain wallet ID associated with a user of a client device.

As used herein, the term “non-blockchain based identifier” represents an identification method for a user of a client device that is not associated with the blockchain network. In one or more examples, the non-blockchain based identifier includes one or more of a phone number, email address, username, user profile, etc.

As used herein, the term “blockchain event” refers to an activity and/or occurrence within the blockchain network. For instance, the blockchain event includes one or more of an authentication of a blockchain wallet, a transaction confirmation, generation and/or exchange of a token, an addition or removal of one or more nodes, etc.

As used herein, a “non-blockchain event” refers to an event and/or activity that occurs as part of an interaction between a client device and a service provider system that is not connected to a blockchain network. For example, a non-blockchain event includes one or more of a web interaction, user interaction, digital content communication, user profile activity, application execution, etc.

As used herein, an “identity asset” refers to a representation of an entity that includes an association between a non-blockchain based identifier and a blockchain identifier. For instance, an identity asset includes an association between a non-blockchain based identifier such as an email address and a blockchain identifier such as a blockchain wallet ID for a user as well as a variety of additional client data. In some examples, an identity asset includes more than one association and/or is representative of two or more entities.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

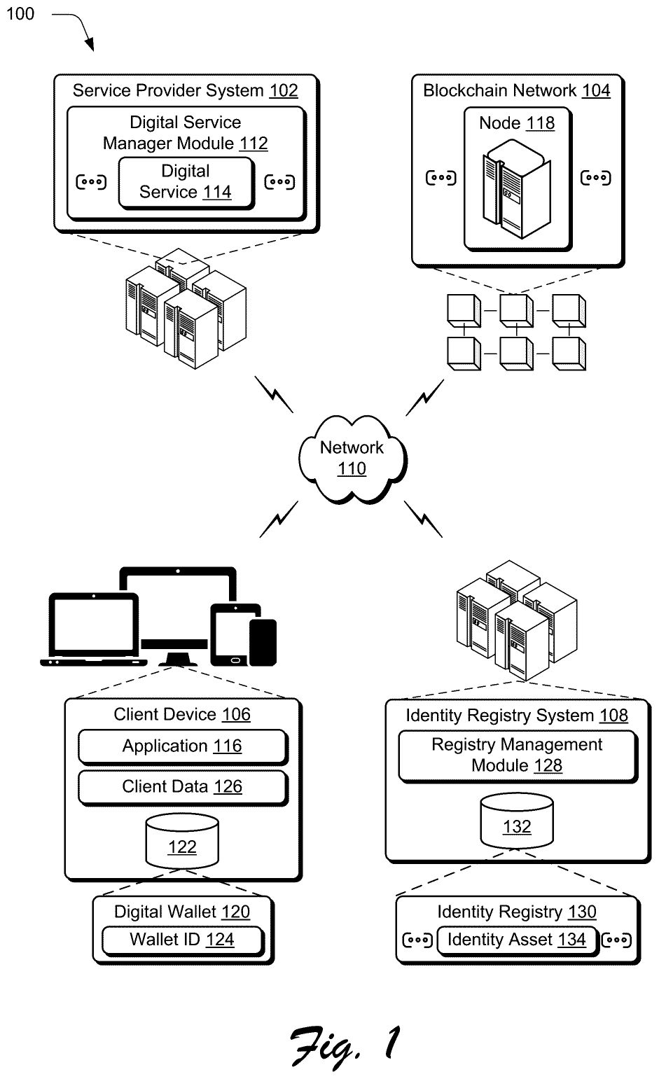

FIG. 1 is an illustration of a unified identity registry environment 100 in an example implementation that is operable to employ the techniques described herein. The unified identity registry environment 100 includes a service provider system 102, a blockchain network 104, a plurality of (e.g., two or more) client devices (an example of which is illustrated as client device 106), and an identity registry system 108 that are communicatively coupled, one to another, via a network 110 such as the Internet.

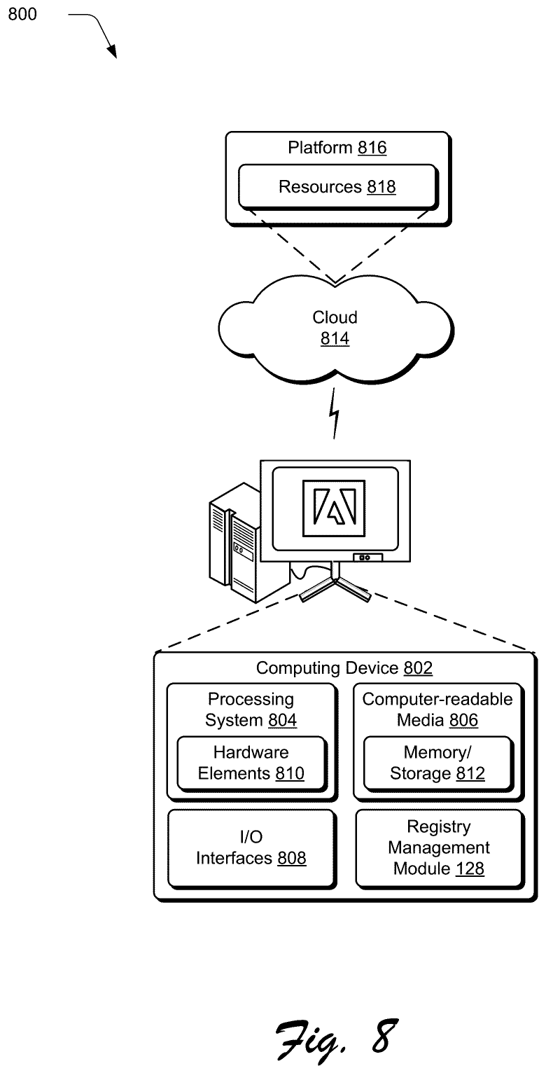

Computing devices that implement the unified identity registry environment 100 are configurable in a variety of ways. A computing device, for instance, is configurable as a processing device such as a desktop computer, a laptop computer, a mobile device (e.g., assuming a handheld configuration such as a tablet or mobile phone), IoT device, a wearable device, AR/VR device, a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 8.

The service provider system 102 includes a digital service manager module 112 that is configured to implement at least one digital service 114. The digital service 114 is executable by the service provider system 102 (e.g., using a processing device and computer-readable storage medium) to implement functionality that is deliverable via the network 110, e.g., to the client device 106. Examples of a digital service 114 include control of access to digital content (e.g., via a streaming digital service), a social media service, software as a service, digital content creation and editing services, digital content sharing service (e.g., a stock digital content service), a generative artificial intelligence (AI) content creation service, various applications, web/browser-based services, block-chained powered services, and so forth.

The client device 106, for instance, executes an application 116 (e.g., a browser or network enabled application) having network functionality to access the digital service 114 via the network 110. The digital service 114 is executable by the service provider system 102 (e.g., via one or more servers) and/or locally through download and execution locally at the client device 106.

The blockchain network 104 is implemented by a plurality of nodes, an example of which is illustrated as node 118. Nodes are implemented using processing, memory, and network resources of respective computing devices that operate as the infrastructure of the blockchain. As part of this, the nodes 118 store, communicate, process, and manage data that makes up the blockchain. Nodes 118 are interconnected as illustrated in FIG. 1 to exchange data via the network 110, e.g., as a peer-to-peer network in a distributed and decentralized manner. For instance, the node 118 supports operation of the blockchain network 104 by maintaining a copy of a blockchain ledger, validating transactions, and/or communicating with other nodes in the blockchain network. In an example, the client device 106, the service provider system 102, and/or the identity registry system 108 participate as one or more nodes within the blockchain network 104.

The client device 106 is illustrated as including a digital wallet 120, which is maintained in a storage device 122 at the client device 106. The digital wallet 120 is configured to store private keys associated with a user's digital address and are used to prove ownership of the assets, sign transactions, and so forth. In an example, the digital wallet 120 is a blockchain wallet that is associated with a blockchain identifier such as a wallet ID 124. The wallet ID 124, for instance, includes a blockchain address as a decentralized identifier to identify the digital wallet 120 as part of the blockchain network 104.

Generally, the digital wallet 120 is configured to interact with a blockchain network 104 and store/maintain various digital assets and/or information. For instance, the digital wallet 120 is configurable to store, maintain, send, and/or receive one or more cryptocurrencies, non-fungible tokens (“NFT's”), decentralized finance tokens, initial coin offerings, transaction history information (e.g., dates, times, transaction amounts, participants, ledger information, etc.), private keys to maintain security of the digital wallet 120, policy holder benefits, etc. This is by way of example and not limitation, and the digital wallet 120 is configured to maintain a variety of assets and/or information.

The client device 106 is further depicted as including client data 126. In an example, the client data 126 is representative of non-blockchain based information about one or more users and/or entities associated with the client device 106 (e.g., user data), information about the client device 106 itself, and/or information about an interaction between the client device 106 and the service provider system 102. In various examples, the client data 126 includes one or more instances of personally identifiable information and/or non-personally identifiable information. For instance, the client data 126 includes one or more names, phone numbers, email addresses, dates-of-birth, anonymous identifiers, device information, user behaviors, demographic information, usage data, computational resources consumption, location information, non-blockchain based financial information, social media data, user preferences, etc. This is by way of example and not limitation and a variety of client data 126 is considered.

The identity registry system 108 is illustrated as including a registry management module 128 that is configured to implement an identity registry 130, which is illustrated as stored in a storage device 132. Generally, the registry management module 128 is operable to generate an association between non-blockchain based data (e.g., the client data 126) and blockchain-based data (e.g., a wallet ID 124) for an entity to generate one or more identity assets 134 which are depicted as maintained in the identity registry 130. The registry management module 128 is further operable to generate, analyze, manage, and/or control access to the identity registry 130, operation of which is further described in the following sections and shown in the corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Unified Identity Registry

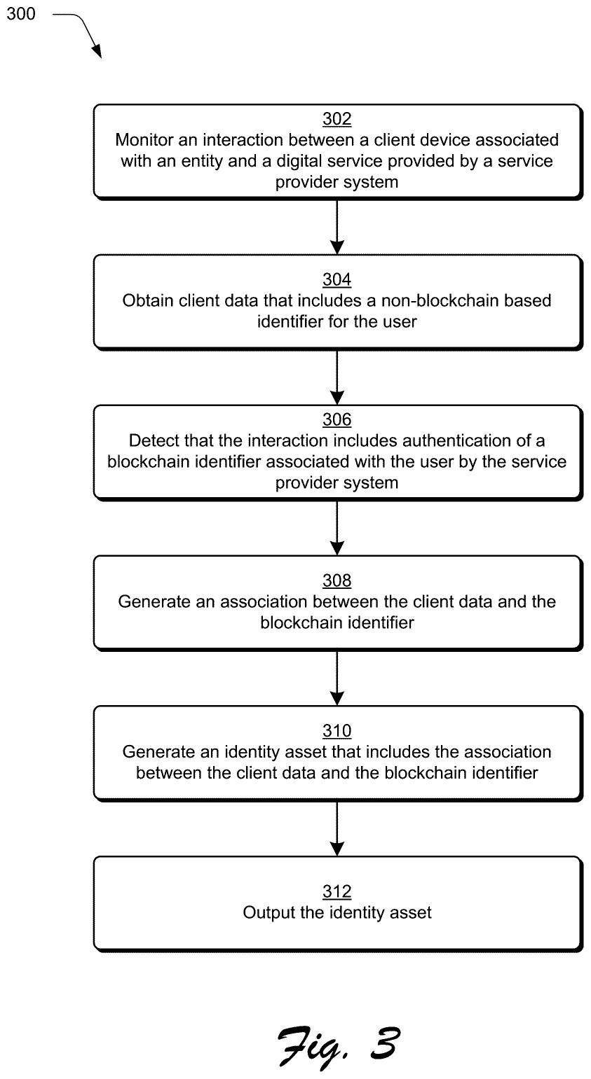

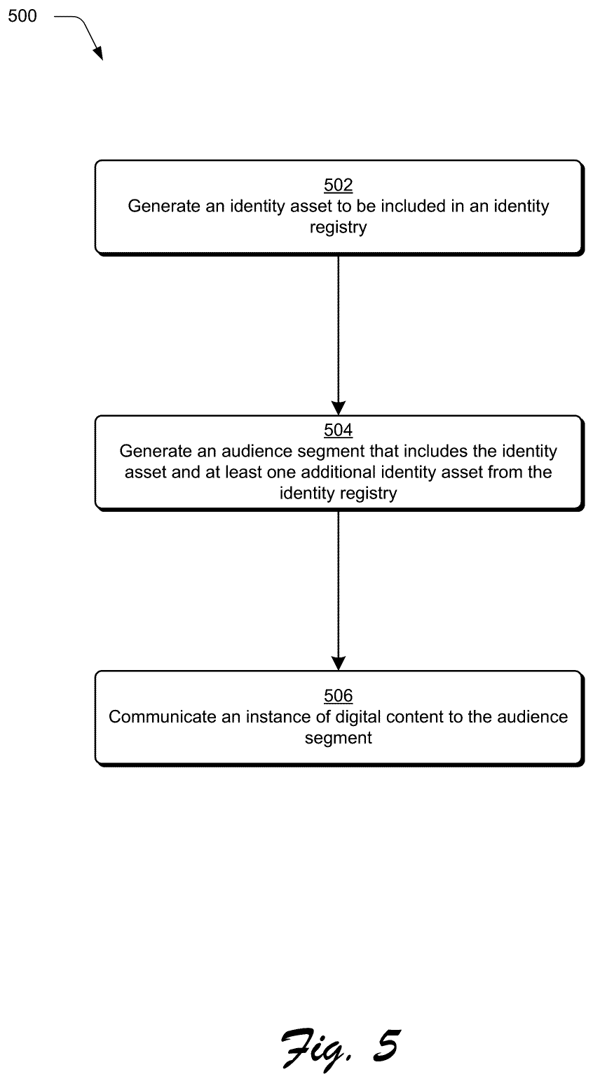

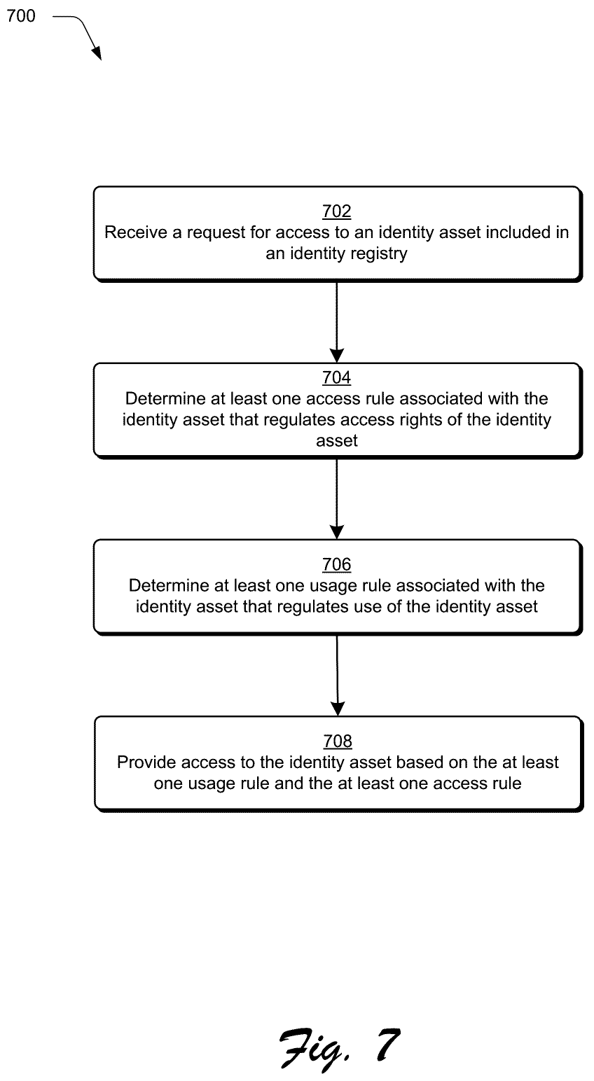

The following discussion describes unified identity registry techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made in parallel with FIG. 3 that depicts a flow diagram of a procedure 300 in an example implementation of generation of an identity asset as part of a unified identity registry, FIG. 5 that depicts a flow diagram of a procedure 500 in an example implementation of generation of an audience segment as part of managing a unified identity registry, and FIG. 7 that depicts a flow diagram of a procedure 700 in an example implementation of providing access to an identity asset as part of managing a unified identity registry.

### Generating an Identity Asset

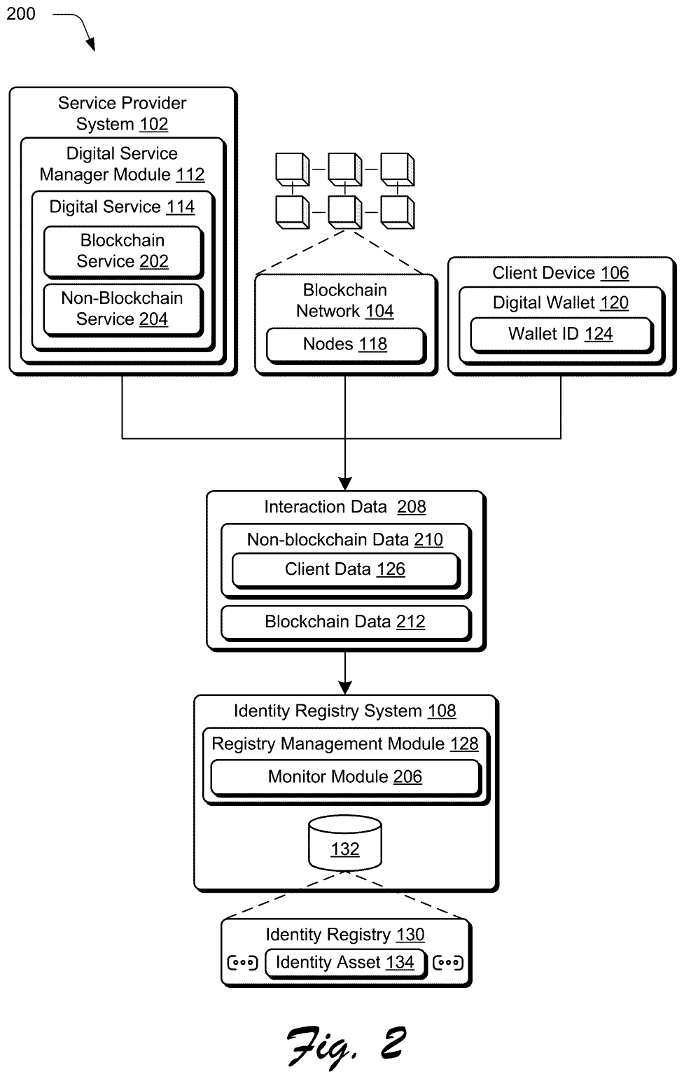

FIG. 2 is an illustration of a system 200 in an example implementation showing operation of the registry management module 128 of FIG. 1 in greater detail as generating an identity asset 134. In this example, a service provider system 102 and a client device 106 represent respective nodes 118 on a blockchain network 104. As described above, the nodes operate as the infrastructure of the blockchain and store, communicate, process, and manage data that makes up the blockchain network 104. For instance, the nodes 118 supports operation of the blockchain network 104 by maintaining a copy of a blockchain ledger, validating transactions, and/or communicating with other nodes in the blockchain network. As respective nodes 118 on the blockchain network 104, the service provider system 102 and the client device 106 are able to access a transaction history of the blockchain network 104.

The client device 106, which is associated with an entity, interacts with a digital service 114 of the service provider system 102. For instance, the service provider system 102 includes a digital service manager module 112 that implements at least one digital service 114. As noted above, a variety of digital services 114 are considered. In one or more examples, the digital service 114 includes a blockchain service 202 and/or a non-blockchain service 204. Generally, a blockchain service 202 supports various functionality that incorporates blockchain technology, such as by leveraging a decentralized ledger and/or cryptographic features of the blockchain network 104. A non-blockchain service 204 includes a variety of functionality that does not involve/rely on the blockchain network 104. In various examples a digital service 114 includes aspects of both a blockchain services 202 and a non-blockchain service 204. For example, the digital service 114 is a browser-based application that supports interactions, e.g., transactions, via the blockchain network 104 as well as interactions that do not involve the blockchain network 104. In at least one example, the digital service 114 is provided by the registry management module 128 for use by the service provider system 102.

The registry management module 128 includes a monitor module 206 that is operable to monitor the interaction between the client device 106 and the digital service 114 provided by the service provider system 102 (block 302). In this example, the monitor module 206 monitors the interaction between the client device 106 and the service provider system 102 directly, e.g., via one or more measurement technologies, tools, and/or techniques. Additionally or alternatively, the monitor module 206 leverages the digital service manager module 112 to monitor the interaction. For instance, the digital service manager module 112 monitors the interaction as part of providing the digital service 114 and communicates monitoring data to the monitor module 206.

In this way, the monitor module 206 is operable to obtain client data 126 that includes a non-blockchain based identifier for the user (block 304). For instance, as part of monitoring the interaction the registry management module 128 collects interaction data 208 that includes non-blockchain data 210 as well as blockchain data 212. In an example, the non-blockchain data 210 includes client data 126 such as information about a user/entity. For instance, the client data 126 includes an identifier associated with the user of the client device 106 such as one or more of an email address, phone number, username, user profile (e.g., a social media profile), IP address, identification number, client device identifier, etc. This is by way of example and not limitation and a variety of client data 126 is considered.

In one or more examples, the non-blockchain data 210 further includes information about the client device 106 itself, such as a device type, hardware specifications, operating system, network information, computational resource consumption, location information, etc. Alternatively or additionally, the non-blockchain data 210 includes information about one or more interactions between the service provider system 102 and the client device 106, such as content that the user was exposed to, session date, page views, click maps, etc.

The monitor module 206 is further configured to detect that the interaction includes one or more blockchain-based operations. For instance, the monitor module 206 detects that the interaction includes authentication of a blockchain identifier associated with the user by the service provider system 102 (block 306). Consider an example in which the interaction includes a blockchain-based transaction between the service provider system 102 and the client device 106. The service provider system 102 authenticates the client device 106 to validate the transaction, such as by authenticating a wallet ID 124 stored in a digital wallet 120 associated with the client device 106. The monitor module 206 detects this interaction, and obtains the blockchain identifier, e.g., the wallet ID 124.

The registry management module 128 then generates an association between the client data 126 and the blockchain identifier (block 308). For instance, the registry management module 128 links the wallet ID 124 with one or more instances of non-blockchain data 210, e.g., a non-blockchain identifier such as an email address, phone number, etc. In an example to do so, the registry management module 128 determines a correlation between an event associated with the non-blockchain based identifier (e.g., a user interaction with a non-blockchain service 204) and a blockchain event associated with the blockchain identifier, e.g., a user interaction with a blockchain service 202.

The registry management module 128 generates an identity asset 134 that includes the association between the client data 126 and the blockchain identifier (block 310). The identity asset 134 therefore represents a unified representation of the user across both blockchain and non-blockchain environments, which is not possible using conventional techniques.

The registry management module 128 is further operable to augment the identity asset 134 by acquiring additional blockchain-based information associated with the user and/or the client device 106. For instance, because the service provider system 102 is representative of a node 118 in the blockchain network 104, the registry management module 128 further has access (e.g., via the service provider system 102) to historical blockchain information associated with the client device 106. Accordingly, in one or more examples the registry management module 128 obtains historical blockchain transaction data associated with the blockchain identifier and augments the identity asset 134 with the historical blockchain transaction data.

Further, the identity registry system 108 is operable to augment the identity asset 134 with additional non-blockchain based data such as additional user identifiers, non-blockchain events related to the digital service, specifications of the client device, etc. In some examples, the registry management module 128 obtains the additional non-blockchain based data from additional service provider systems.

Once generated, the registry management module 128 is configured to output the identity asset 134 (block 312). In one example, the registry management module 128 configures the identity asset 134 for display and subsequently outputs the identity asset 134 in a user interface of a processing device. Alternatively or additionally, the registry management module 128 communicates the identity asset 134 to one or more service provider systems 102. In various examples, the registry management module 128 stores the identity asset 134 in an identity registry 130, which is depicted in this example as maintained in storage device 132. This functionality is described in more detail below.

### Generating and Managing an Identity Registry

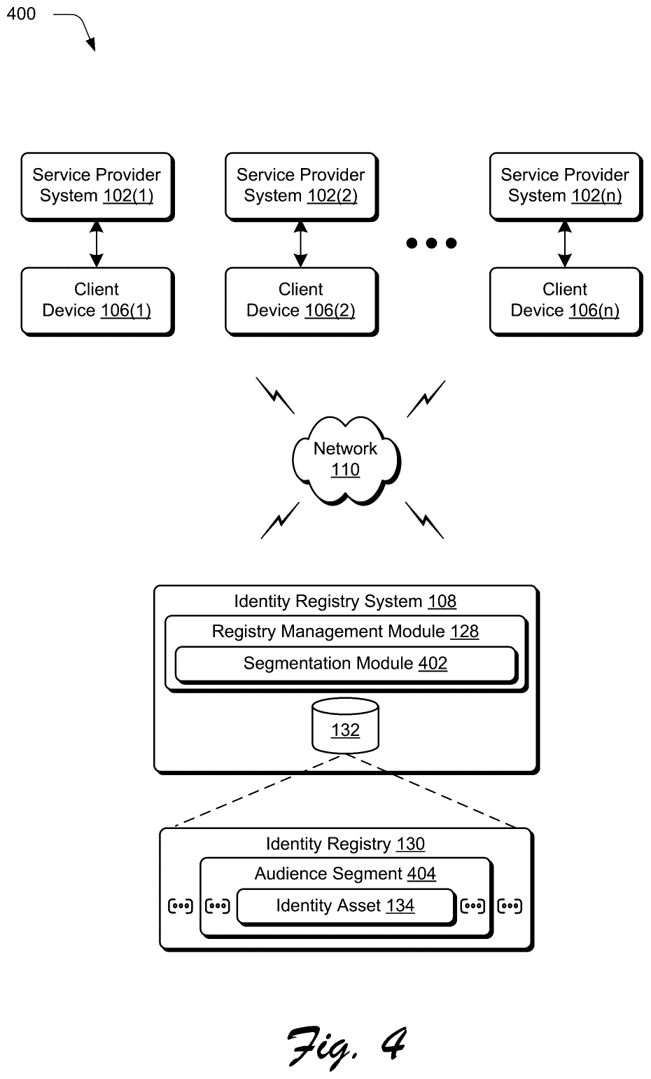

FIG. 4 is an illustration of a system 400 in an example implementation of generating and maintaining an identity registry. In the illustrated example, a plurality of service provider systems are depicted as interacting with a variety of client devices. For instance, a service provider system 102(1) is shown interacting with a client device 106(1), a service provider system 102(2) is shown interacting with a client device 106(2), and a service provider system 102(n) is shown interacting with a client device 106(n) where n represents an “n^{th}” number of interactions. Although not depicted in this illustrated example, it should be understood that in various examples multiple client devices 106 interact with a respective service provider system 102.

For each interaction between a service provider system 102 and client device 106, the registry management module 128 is operable to generate a respective identity asset 134 to be included in an identity registry 130 (block 502). The identity assets 134 are generated in accordance with the techniques described above, and thus each identity asset 134 includes a blockchain identifier and a non-blockchain based identifier associated with an entity such as a user of a client device 106. In the illustrated example, the identity registry 130 is depicted as maintained in a storage device 132 of the identity registry system 108. The registry management module 128 also iteratively updates the identity registry 130, such as to add/remove identity assets 134 and/or update identity assets 134 in real time or asynchronously.

The registry management module 128 is depicted as including a segmentation module 402 that is operable to perform complex data analysis based on the identity assets 134 included in the identity registry 130 to generate one or more audience segments 404. For instance, the segmentation module 402 generates an audience segment 404 that includes the identity asset 134 and at least one additional identity asset from the identity registry 130 (block 504). Because the identity assets 134 in the identity registry 130 include non-blockchain based data and blockchain based data, the audience segments 404 are based on either or both the non-blockchain based data and/or the blockchain based data. Further, because in some examples the identity registry includes identity assets 134 from multiple service provider systems, the segmentation module is operable to generate audience segments 404 based on correlations between identity assets 134 across multiple service provider systems which is not possible using conventional systems.

In one example, the segmentation module 402 generates an audience segment 404 based on a correlation of a non-blockchain event to a blockchain event. For instance, the segmentation module 402 determines a contribution of a particular blockchain event to the occurrence (or non-occurrence) of a particular non-blockchain event. Additionally or alternatively, the segmentation module 402 attributes a contribution of a particular non-blockchain event to the occurrence or non-occurrence of a particular blockchain event. In this way, the techniques described herein support cross-modality analysis, such as between blockchain and non-blockchain modalities, which is not possible using conventional approaches.

In another example, the segmentation module 402 generates the one or more audience segments 404 based on a correlation of the blockchain identifier and/or the non-blockchain based identifier to one or more metrics such as key performance indicators and/or a lifetime value score. A lifetime value score, for instance, represents a predicted value of the user over a duration of the user's relationship with the service provider system 102. A key performance indicator, for example, represents a quantifiable metric that corresponds to an objective. In one or more examples, the key performance indicators relate to one or more of a conversion rate, computational efficiency, completeness of data, etc. For instance, the segmentation module 402 generates a segment that includes identity assets 134 to minimize computational resource consumption across either or both non-blockchain and blockchain environments.

In an additional or alternative example, the segmentation module 402 generates the audience segment 404 based on a historical blockchain event associated with the blockchain identifier. For instance, the segmentation module 402 analyzes previous blockchain transactions associated with an identity asset 134 as part of generating the one or more audience segments 404.

In some examples, an audience segment 404 is based on input received from a service provider system 102. For instance, the service provider system 102 generates groupings and/or subsets of users and the segmentation module 402 generates one or more audience segments 404 based on such groupings. The segmentation module 402 is further operable to generate additional audience segments 404 based on groupings received from multiple service provider systems. Such collaborative analysis is not supported using conventional approaches. In various embodiments, the segmentation module 402 leverages one or more machine learning models to analyze the information stored in the identity registry 130 to generate an audience segment 404.

The registry management module 128 leverages the one or more audience segments 404 in a variety of ways. For instance, the registry management module 128 communicates an instance of digital content to an audience segment 404 (block 506). Because the audience segment 404 is based on both non-blockchain and blockchain based data, targeted delivery of digital content to the audience segment 404 reduces computational resource wastage. In another example, the registry management module 128 leverages the audience segment 404 to engage the identity assets 134 included in the audience segment 404 in a blockchain event. Alternatively or additionally, the registry management module 128 communicates the audience segment 404 to one or more service provider systems 102 as described in more detail in the following examples.

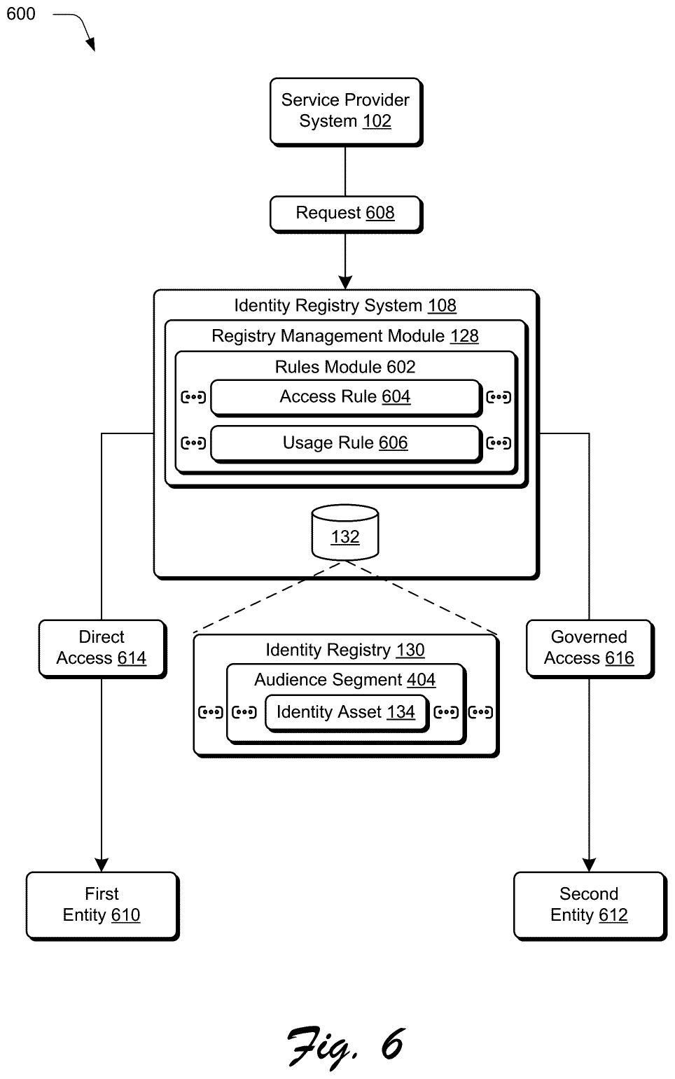

FIG. 6 is an illustration of a system 600 in an example implementation of generating one or more rules as part of maintaining an identity registry 130. In this example, the registry management module 128 includes a rules module 602 that is operable to define one or more rules to govern the identity registry 130. For instance, the rules module 602 defines one or more access rules 604 and/or one or more usage rules 606 associated with the identity assets 134 and/or the audience segments 404. In various examples, the access rules and/or usage rules are based in part on input from the service provider system 102.

Generally, a usage rule 606 regulates use of a particular identity asset 134 or audience segment 404. That is, a usage rule 606 regulates “how” an identity asset 134 and/or an audience segment 404 is to be used. By way of example, a usage rule 606 restricts use of an identity asset 134 based on a privacy restriction, such as to prevent use of the identity asset 134 in a manner that would compromise PII of the identity asset 134. In another example, a usage rule 606 restricts use of an identity asset 134 and/or an audience segment 404 for a particular application or technology. For instance, the usage rule 606 restricts use of an identity asset 134 by an application with computational resource consumption over a threshold level.

An access rule 604 regulates access rights of the identity asset 134, such as by various service provider systems 102. In other words, the access rule 604 dictates “who” is allowed to access “what” aspects of identity assets 134 and/or audience segments 404. In an example, an access rule 604 allows a designated entity to download data directly from the identity registry 130, e.g., the access rule 604 permits unrestricted access to the identity asset 134. Additionally or alternatively, an access rule 604 restricts a particular entity, partially or wholly, from accessing one or more identity assets 134. For instance, the access rule 604 restricts visibility of data included in the identity asset 134.

In another example, an access rule 604 provides “governed access” to an identity asset 134 for a particular entity, such that the particular entity is allowed to access the identity asset 134 in a limited manner without visibility into the information included in the identity asset 134. In yet another example, the access rule 604 regulates sharing permissions of the identity asset 134, such as to regulate sharing of the identity asset 134 by third party service provider systems that are granted access to the identity asset 134.

In this way, the identity registry system 108 is operable to manage data sharing between different service provider systems 102 in a customizable manner. For instance, in the illustrated example, the identity registry system 108 receives a request 608 for access to the identity registry 130, such as to access a particular identity asset 134 or audience segment 404 (block 702). In this example, the request 608 is generated by the service provider system 102 to grant access to an identity asset 134 to a first entity 610, e.g., a second service provider system, and a second entity 612, e.g., a third service provider system. This is by way of example and not limitation, and in some examples the request 608 is generated by one or more of the identity registry system 108 and/or a different service provider system. In various examples, the request 608 is generated automatically and without user intervention.

The identity registry system 108 then determines an access rule 604 associated with the identity asset 134 (block 704). As described above, the access rule 604 regulates “who” is allowed to access the identity asset 134 and in what capacity. In this example, the access rule 604 specifies that the first entity 610 has direct access 614 permission, and thus is allowed to download data pertaining to the identity asset 134 directly from the identity registry 130. The access rule 604 further provides governed access 616 to the second entity 612, such that the second entity 612 is allowed to access the identity asset 134 in a limited manner.

The rules module 602 further determines at least one usage rule 606 associated with the identity asset 134 (block 706). As described above, the usage rule 606 regulates use of the identity asset 134. For instance, the usage rule 606 limits use of the identity asset 134 for particular applications by the first entity 610 and/or the second entity 612.

The identity registry 130 then provides access to the identity asset 134 based on the usage rule 606 and the access rule 604 (block 708). In this example, the identity registry 130 grants direct access 614 to the first entity 610 and governed access 616 to the second entity 612 based on the access rule 604. Further, the identity registry 130 is operable to restrict use of the identity asset 134 based on the usage rule 606, such as to limit use cases of the identity asset 134 based on one or more privacy restrictions associated with the identity asset 134. In this way, the techniques described herein provide a holistic and customizable data sharing modality that integrates non-blockchain based user data and blockchain-based user data into a comprehensive identity registry 130.

### Example System and Device

FIG. 8 illustrates an example system generally at 800 that includes an example computing device 802 that is representative of one or more computing systems and/or devices that implement the various techniques described herein. This is illustrated through inclusion of the registry management module 128 The computing device 802 is configurable, for example, as a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
monitoring, by a processing device, an interaction between a client device associated with a user and a digital service provided by a service provider system;
obtaining, by the processing device, client data that includes a non-blockchain based identifier for the user;
detecting, by the processing device, that the interaction includes authentication of a blockchain identifier associated with the user by the service provider system;
generating, by the processing device, an association between the client data and the blockchain identifier; and
outputting, by the processing device, an identity asset that includes the association between the client data and the blockchain identifier.

2. The method as described in claim 1, wherein the interaction includes a digital transaction between the user and the service provider system using a blockchain wallet and the blockchain identifier is associated with the blockchain wallet.

3. The method as described in claim 1, wherein the non-blockchain based identifier includes one or more of an email address, a phone number, a username, or a client device identifier.

4. The method as described in claim 1, further comprising obtaining, by the processing device, historical blockchain transaction data associated with the blockchain identifier and augmenting the identity asset with the historical blockchain transaction data.

5. The method as described in claim 1, wherein the generating the association includes determining a correlation between an event associated with the non-blockchain based identifier and a blockchain event associated with the blockchain identifier.

6. The method as described in claim 1, further comprising generating, by the processing device, an identity registry that includes the identity asset and at least one additional identity asset.

7. The method as described in claim 6, wherein the identity registry includes a plurality of audience segments that each include two or more identity assets, the plurality of audience segments generated based on correlations between blockchain identifiers and non-blockchain based identifiers for the respective identity assets.

8. The method as described in claim 1, wherein the identity asset is associated with a usage rule that regulates use of the identity asset and an access rule that regulates access rights of the identity asset.

9. A system comprising:
a memory component; and
a processing device coupled to the memory component, the processing device to perform operations including:
generating an identity asset to be included in an identity registry, the identity asset including a blockchain identifier and a non-blockchain based identifier associated with an entity;
generating an audience segment that includes the identity asset and at least one additional identity asset from the identity registry, the audience segment based on the blockchain identifier and the non-blockchain based identifier; and
communicating an instance of digital content to the audience segment.

10. The system as described in claim 9, wherein the audience segment is generated based on a correlation between a non-blockchain event associated with the non-blockchain based identifier and a blockchain event associated with the blockchain identifier.

11. The system as described in claim 9, wherein the audience segment is generated based on a correlation between a key performance indicator and one or more of the blockchain identifier and the non-blockchain based identifier.

12. The system as described in claim 9, wherein the audience segment is generated based on a historical blockchain event associated with the blockchain identifier.

13. The system as described in claim 9, the operations further including monitoring an interaction between a client device associated with the identity asset and a digital service provided by a service provider system, and updating the audience segment based on the interaction.

14. The system as described in claim 9, the operations further including defining one or more access rules that regulate access to the audience segment and wherein the communicating the digital content to the audience segment is performed in accordance with the one or more access rules.

15. The system as described in claim 9, the operations further including defining one or more usage rules that regulate use of the audience segment and wherein the communicating the digital content to the audience segment is performed in accordance with the one or more usage rules.

16. A non-transitory computer-readable storage medium storing executable instructions, which when executed by a processing device, cause the processing device to perform operations comprising:
receiving a request for access to an identity asset included in an identity registry, the identity asset including an association between a blockchain identifier and a non-blockchain based identifier for an entity;
determining at least one usage rule associated with the identity asset that regulates use of the identity asset and at least one access rule associated with the identity asset that regulates access rights of the identity asset; and
providing access to the identity asset based on the at least one usage rule and the at least one access rule.

17. The non-transitory computer-readable storage medium as described in claim 16, wherein the at least one access rule restricts visibility of data included in the identity asset.

18. The non-transitory computer-readable storage medium as described in claim 16, wherein the at least one access rule permits unrestricted access to the identity asset from the identity registry.

19. The non-transitory computer-readable storage medium as described in claim 16, wherein the at least one usage rule restricts use of identity asset based on one or more privacy restrictions.

20. The non-transitory computer-readable storage medium as described in claim 16, wherein the at least one access rule permits a service provider system to access the identity asset and regulates sharing permissions of the identity asset for the service provider system to an additional service provider system.
